(19) United States
(12) Patent Application Publication
(10) Pub. No.: US 2026/0017483 A1
(43) Pub. Date: Jan. 15, 2026

(54) Modified Transformer for Time Series Forecasting

(71) Applicant: Rakuten India Enterprise Private Limited, Bengaluru (IN)

(72) Inventors: Kiran Batni Raghavendra Rao, Bengaluru (IN); Archit Sud, Bengaluru (IN); Gaurav Kumar Mahakud, Bengaluru (IN); Rakshit Arora, Bengaluru (IN); Aditya Pratap Saha, Kolkata (IN)

(73) Assignee: Rakuten India Enterprise Private Limited, Bengaluru (IN)

(21) Appl. No.: 19/261,343

(22) Filed: Jul. 7, 2025

Related U.S. Application Data
(60) Provisional application No. 63/669,243, filed on Jul. 10, 2024.

(51) Int. Cl. G06N 3/04

(52) U.S. Cl. CPC G06N 3/04

(57) ABSTRACT

Disclosed below is a system and method for time series forecasting using a modified transformer. The modified transformer comprises of a genome sequence embedded which replaces the decoder in a traditional transformer for time series forecasting. Further, the disclosed system and method can also be used for an accurate and reliable prediction and forecasting, which also drastically reduces the processor requirements and the time required. The core of the invention is the genome layer which is present in the transformer for time series forecasting, which determines the connections and configuration of the neural network.

### TECHNICAL FIELD

Various embodiments of the present disclosure relates generally to computer systems and processes for artificial intelligence, and, more particularly to machine learning methods and neural networks used in artificial intelligence for time series forecasting and predictions. More particularly, the present invention relates to the field of computer monitoring systems using artificial intelligence, specifically to methods and systems for anomaly detection and root cause analysis in distributed computing environments.

### BACKGROUND

Computer technology has grown exponentially in the recent times and there has been cutting edge breakthrough in computer technology and more so in artificial intelligence. One of the important use cases of artificial intelligence is for forecasting and prediction.

Traditionally and the current existing solutions use neural networks for making predictions and forecasts. Deep neural network models have been widely used in time series forecasting. For example, learning models may be used to forecast time series data such as continuous market data over a period of time in the future, weather data, and/or the like. Existing deep models adopt batch-learning for time series forecasting tasks.

Another latest advancement in time series forecasting and predictions is the use of transformers and neural networks for the same. While transformers are effective in text-to-text or text-to-image models, there are several challenges when applying transformers to time series. Moreover, all these transformer models lack accuracy when it comes to time series forecasting.

In the rapidly evolving realm of artificial intelligence, the ability to accurately forecast time-series data plays a pivotal role in maintaining accuracy and reliability of the results, optimizing resource utilization, and proactively addressing potential issues. Time series forecasting typically entails using historical data to identify patterns and predict future trends and make forecasts, within a specific timeframe and context. Traditional forecasting models often fall short when dealing with the complex and dynamic nature of data, leading to suboptimal decision-making and increased operational risks. Moreover, the conventional methods of time series forecasting using transformers and neural networks require huge amount of training data and extensive training and long hours of training for the artificial intelligence models. Conventional techniques are commonly time-intensive and include significant memory complexity. In a lot of use case, there is unavailability of extensive training data and also lack of time.

Moreover, traditional monitoring systems for anomaly detection rely on static thresholds that fail to adapt to changing conditions, resulting in excessive false positives or missed anomalies. Furthermore, there is also prolonged resolution times and potential business impact. In the rapidly evolving realm of IT operations, the ability to accurately forecast time-series data plays a pivotal role in maintaining system reliability, optimizing resource utilization, and proactively addressing potential issues. Traditional forecasting models often fall short when dealing with the complex and dynamic nature of different environments, leading to suboptimal decision-making and increased operational risks.

The existing forecasting techniques lacks the adaptability and scalability required to handle the intricacies of time series forecasting. The conventional approaches, such as autoregressive models and statistical methods, often struggle to capture the non-linear dependencies, seasonality patterns, and anomalous behaviours in the data. Moreover, the increasing volume, velocity, and variety of data generated by diverse components demand a more sophisticated and domain-specific forecasting solution.

Currently there is a need for an integrated system that can automatically configure neural networks without much training data and also save huge amount of memory space and time required for processing. There is also a need for an advanced Transformer architecture tailor-made for time-series forecasting tasks.

In light of above-mentioned problems and shortcomings associated with the existing methods of time series forecasting, there is a need for an advanced model, method and system for time series forecasting which could provide users with accurate and reliable results within a short time frame and with as much less data as possible.

### SUMMARY

Embodiments of the present disclosure present technological improvements as solutions to one or more of the above-mentioned technical problems recognized by the inventor in conventional systems.

The present invention discloses a system and method a modified transformer with a genome sequence. Further disclosed below is a system and method for time series forecasting using the modified transformer with a genome sequence.

In the primary embodiment of the present invention, it discloses a method and a system comprising a hardware processor communicably coupled via a communication network with one or more neural networks, wherein the processor is configured to enable the neural network to perform time series forecasting. The disclosed neural network is a transformer model specifically designed for time series forecasting. The novel aspect is a genome sequence in the transformer layer of the transformer model which determines the connection between the neural network, their hyper parameters and their configurations.

In one of the primary embodiments of the present invention, the system comprises of a transformer comprising at least a dense layer, a transformer layer, a reshape layer and a time-distributed layer. The said transformer layer further comprises an encoder layer, a genome layer and a normalization layer.

A primary embodiment of the present invention discloses a method for detecting anomalies using a modified transformer for time series forecasting, comprising receiving at least one or more time series input data and one or more environment data, from an input device; identifying one or more relationships between one or more sequence of inputs by at least one encoder layer; determining one or more connections between one or more neural networks and a configuration of the one or more neural networks based on one or more genome sequence in at least one genome layer, wherein the one or more genome sequence change with any changes in at least the one or more environment data; computing one or more preliminary output data by combining one or more initial output from one or more nodes associated with the one or more neural networks by the at least one genome layer; and normalizing the one or more preliminary output data received from the at least one genome layer.

In another embodiment of the same disclosure, the processor is configured to run computer implemented method steps, to provide time series forecasting outputs for the provided inputs, identify dynamic thresholds and also detect anomalies in the different environments for which the input data corresponds to and also automatically rectify the anomalies.

Without limitation, the disclosed system and methods is used for AIOps (Artificial Intelligence for IT Operations) with accuracy and efficiency in predicting IT system behaviours and performance metrics.

Beneficially, the disclosed invention provides a method for setting up a neural network very quickly, reducing the processing time required and also with much lesser training data needed, thereby drastically reducing the processing time and also provides more accurate results. Disclosed system also beneficially provides a comprehensive system that collects and processes time series data from multiple sources, decomposes time series to identify patterns and trends, applies forecasting models to predict future values, implements dynamic thresholding for anomaly detection and performs AI-based root cause analysis to identify causal relationships between metrics, thereby reduces mean time to resolution through automated identification of root causes and anomalies in computer environments.

Additional aspects, advantages, features and objects of the present disclosure would be made apparent from the and the detailed description of the illustrative embodiments that follow.

While the systems and methods are illustrated by use of computer enabled embodiments and applications, they are equally applicable to virtually any portable or mobile communication device, including for example, computers laptops and other types of processors.

### BRIEF DESCRIPTION OF DRAWINGS

The summary above, as well as the following description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a block diagram of a modified transformer system for time series forecasting as per the disclosed invention.

FIG. 2 depicts a block diagram of a transformer layer as per the disclosed invention.

FIG. 3 depicts a block diagram of a sample embodiment of a modified transformer system for time series forecasting per the present disclosure.

FIG. 4 depicts method steps of time series forecasting using a modified transformer according to an embodiment of the present disclosure.

FIG. 5 depicts method steps of anomaly detection using a modified transformer according to an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention discloses a method and system for time series forecasting using a modified transformer. Disclosed system and method comprises of a transformer with an embedded genome sequence. Unlike traditional transformers which includes a decoder layer, the present invention doesn't have the decoder layer. The decoder layer in the transformer is replaced by a genome layer comprising a genome sequence. The disclosed invention also teaches an artificial intelligence enabled system and method to be used for anomalies detection and rectification in different environments, by collecting data from multiple sources, using time series forecasting and predicting anomalies.

The disclosed invention introduces a revolutionary Transformer architecture designed specifically for time-series forecasting The proposed Transformer-based Time-Series Forecasting model leverages a series of parameters and factors to deliver unparalleled accuracy and efficiency in predicting system behaviors and performance metrics, which can be used for detecting anomalies in different environments. The disclosed system can be modified and tailor made to be used for specific use cases such as in the Information Technology (IT) domain, more specifically for Artificial Intelligence for IT Operations (AIOps).

Generally, transformer model consists of two key component, encoder components and decoder components. The encoder components comprise Input Embedding, which converts input tokens into dense vector representations, Positional Encoding, which adds positional information to the embeddings to account for the order of tokens, Multi-Head Self-Attention, which allows each token to attend to every other token in the input sequence, capturing dependencies, Feed-Forward Neural Network, which applies a fully connected network to each position independently, Residual Connections and Layer Normalization, which helps in training deep networks by stabilizing and accelerating convergence. The Decoder components comprises Input Embedding and Positional Encoding, which is similar to the encoder, but it is meant for the target sequence, a Masked Multi-Head Self-Attention, which ensures that each position can only attend to earlier positions, preventing information leakage from future tokens, a Multi-Head Attention, which attends to the encoder's output, allowing the decoder to focus on relevant parts of the input sequence, a Feed-Forward Neural Network, which is similar to the one in the encoder and a Residual Connections and Layer Normalization, which is similar to the one in the encoder.

However, in the disclosed invention, the transformer layer comprises of Encoder layer, a Genome Layer comprising a genome sequence and a Normalization Layer instead of a traditional Encoder and Decoder layers. The Encoder layer disclosed in the present invention is like any other encoder layer in traditional transformer models, which helps in capturing relationships between different sequence of the input. The multi-head self-attention mechanism within the encoder layer allows the model to focus on distant parts of the sequence, making it better at handling long-term dependencies. The encoder layer in the present invention comprise Input Embedding, which converts input tokens into dense vector representations, Positional Encoding, which adds positional information to the embeddings to account for the order of tokens, Multi-Head Self-Attention, which allows each token to attend to every other token in the input sequence, capturing dependencies, Feed-Forward Neural Network, which applies a fully connected network to each position independently, Residual Connections and Layer Normalization, which helps in training deep networks by stabilizing and accelerating convergence. The Genome layer in the present invention comprises genome sequence which is the replacement of the typical decoder layer and computes output by combining outputs of nodes associated with active genes. The Genome layer has one or more genome sequence which defines how the neural network layers which are part of the model are connected to each other. The genome sequence varies for different environments and parameters. Basically, the genome sequence can be called as a neural network for neural networks, defining the structure and connections and drastically reducing the processing requirements, training data and time.

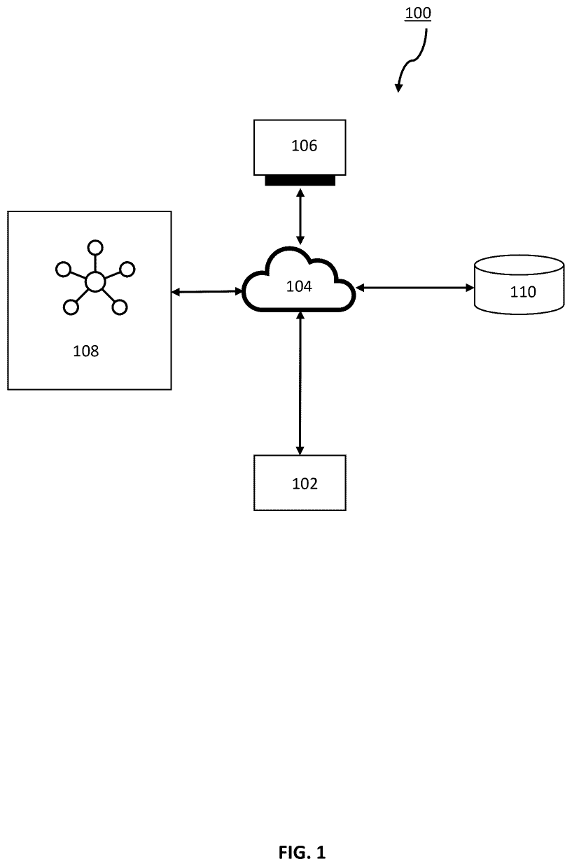

FIG. 1 depicts a block diagram of a modified transformer for time series forecasting as per the disclosed invention. In the primary embodiment of the present invention, it discloses a system 100 comprising a hardware processor 102 communicably coupled via a communication network 104 with one or more user devices 106, a forecasting transformer model 108 and a memory device 110, wherein the processor enables the forecasting transformer model 108 to predict one or more time series forecasts depending on the input data provided by a user using the user device 106.

A primary embodiment of the disclosed system comprises a forecasting transformer model 108 designed for time series forecasting. The model comprises at least a dense layer, an instantiation of the Transformer neural network layer, reshaping layer, and time-distributed layer.

In one of the embodiments of the present invention, the dense layer of the disclosed invention is designed to process the time-series data points, each of which contains a value and a timestamp. The output of the dense layer is a single value that represents the combined information of the value and timestamp from the time-series data point. This single value retains the essential information needed for further processing by the model.

In another embodiment of the same invention, the encoder layer of the present invention is one of the key layers. Similar to any other encoder layer in transformer, it helps capturing relationships between different sequence of the input. The multi-head self-attention mechanism allows the model to focus on distant parts of the sequence, making it better at handling long-term dependencies.

In another embodiment of the same invention, the phase layer of the present disclosure consists of a genome sequence which is derived by continuous experimentation and provides the best result on different time series datasets. This layer is the replacement of the typical decoder layer and computes output by combining outputs of nodes associated with active genes.

In some other embodiment of the same invention, the normalization layer of the disclosed invention ensures that the activations and gradients within the model remain within manageable ranges, contributing to stable training and improved performance. Further in yet another embodiment of the disclosure, the reshape layer of the present invention takes the output from different neurons, each producing its own data stream, and reshapes it into a continuous data structure. Furthermore, in one of the embodiments, the Time-Distribution Layer of the present invention converts the output stream from reshape layer into time-series data.

One of the primary embodiments of the present invention comprises a model which comprises an added addition layer consisting of a genome sequence in transformer model which helps in forecasting the time-series. This sequence defines how these neural network layers which are part of the genome sequence connected to each other. The genome sequence may contain information such as the architecture of the neural network and the hyperparameters.

The memory device or the database serves as a knowledge repository that stores, without limitation, the input data, training data, various codes and even the output data.

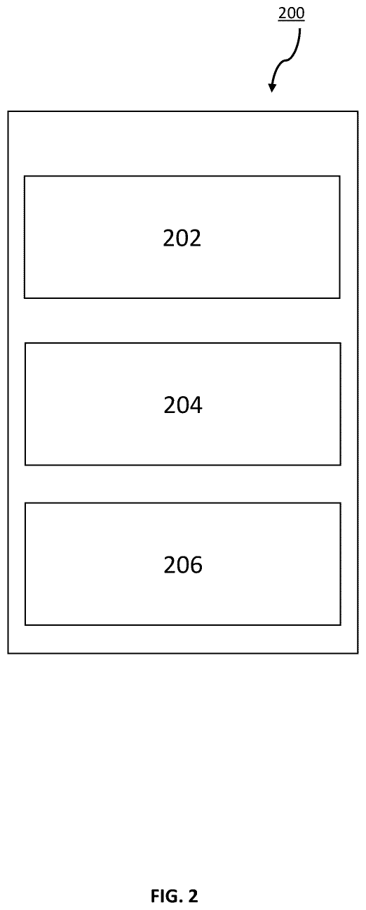

Another primary embodiment of the present invention discloses a computer implemented system for time series forecasting using a modified transformer. FIG. 2 depicts a transformer layer as per one of the embodiments of the disclosed invention. The system and method comprises of the transformer layer 200, having an encoder layer 202, a genome layer 204 and a normalization layer 206. The transformer layer 200 comprises the encoder layer 202, which is similar to any encoder layers in a traditional transformers used for time series forecasting. It helps in capturing relationships between different sequence of the input. It has a multi-head self-attention mechanism, which allows the model to focus on distant parts of the sequence making it better for handling long term dependencies. The transformer layer 200 also comprises the genome layer 204, which consists a genome sequence which defines how these neural network layers which are part of the genome sequence connected to each other. It is adaptive and can automatically change based on the inputs, parameters and requirements. It can be considered as a neural network for the neural network. In the present invention, the disclosed genome sequence is capable of setting up and configuring a neural network, which detects anomalies in IT systems. This layer is the replacement of typical decoder layer in a traditional transformer and it computes output by combining outputs from nodes associated with active genes. Instead of setting up the neural network manually, the system automatically sets up the same. The transformer layer 200 further comprises the normalization layer 206 which ensures that the activations and gradients within the model remain within manageable ranges, contributing to stable training and improved performance.

In the present invention, a dense layer is connected to the Transformer layer 200, which provides the input to the transformer layer. Further, the transformer layer is connected to a reshape layer which takes one or more outputs from one or more different genomes in the transformer layer, each producing its own data stream and reshapes it into a continuous data structure. It is further connected to a time distributed layer, which transforms the output from the reshape layer and transforms it into a time series data.

The core of the disclosed invention model incorporates a genome sequence, functioning as a crucial element in guiding the construction of the neural network architecture. This genome sequence serves as a genetic blueprint, encapsulating architectural specifications, configurations, connections and hyperparameters essential for optimizing the model's forecasting process. The architecture of the model is meticulously structured, comprising integral components engineered to process time series data with precision and efficiency. These components synergistically work t together, guiding a series of transformations aimed at adapting and refining the data. Through successive transformations and iterative optimization processes, the model continuously enhances its forecasting capabilities, ensuring accurate predictions for time series data.

In one of the embodiments of the present invention, Iterative optimization used to reach the final genome comprises steps of pruning the search space, exhaustive grid search, randomized search to sample hyper-parameter combinations and determine an epoch budget. Thereafter, the genome with the best validation/test MSE is selected.

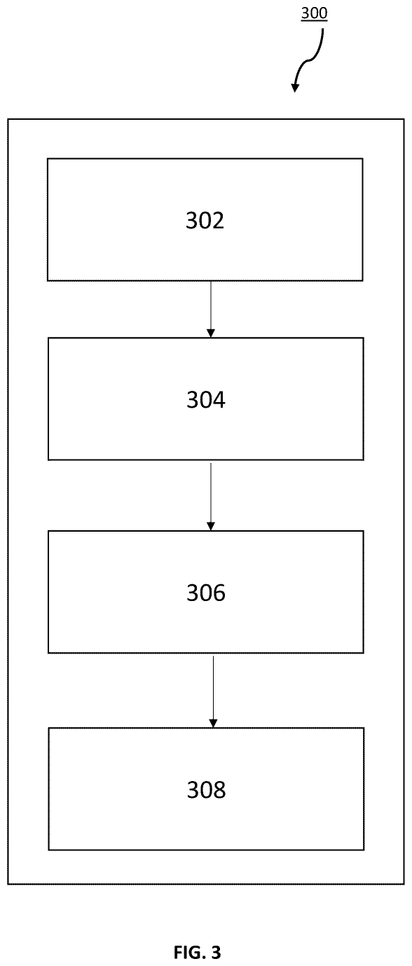

FIG. 3 depicts a sample embodiment of a modified transformer system for time series forecasting per the present disclosure. The disclosed system 300 comprises a dense layer 302, transformer layer 304, a reshape layer 306 and a time distributed layer 308. Input data is fed to the dense layer 302 and the forecast output is received from the time distributed layer. The said modified transformer comprises of a transformer layer 304, with a genome sequence embedded within.

One of the embodiments of the present invention, without limitation can also be used for time-series data from IT operations domain. Alternate embodiments of the same invention can be used for other business cases of time series forecasting as well.

In the disclosed invention, the one or more inputs to the disclosed system and methods is time series metric data which comprises one or more time stamp, one or more values and one or more meta information pertaining to one or more metrics. The input may also contain information pertaining to the environment which the information pertains to, such as AIOps, IT, Ecommerce, etc. The output of the disclosed system and methods is one or more forecasted time series value, along with dynamic thresholds, including upper thresholds and one or more lower thresholds for the one or more metrics.

Another embodiment of the same disclosure can also be adapted for providing Dynamic thresholding, facilitated by the innovative approach in the disclosed invention. It represents a dynamic and adaptive paradigm in anomaly detection. Unlike traditional static thresholding methods, which rely on fixed thresholds, the disclosed invention model dynamically adjusts thresholds based on the prevailing state of the data. This adaptive nature enables the disclosed invention model to account for seasonality, trends, and other temporal patterns, thereby significantly enhancing sensitivity in detecting anomalies.

The disclosed invention dynamic thresholding model establishes both upper and lower thresholds, serving as pivotal benchmarks in anomaly detection. When evaluating forecasted values, surpassing the upper threshold flags anomalies, allowing for swift identification and response to deviations from expected patterns. This dynamic approach not only enhances anomaly detection capabilities but also empowers decision-makers with actionable insights.

Another embodiment can also be implemented for Capacity planning so as to minimize the risk of resource shortages or excess, enhancing operational efficiency and cost-effectiveness. It enables organizations to maintain optimal performance levels while adapting to changing business requirements seamlessly.

The disclosed system and method can be used for anomalies detection in different computer and IT Infrastructure such as E-commerce portals, IT infrastructure for different industries such as, without limitation, Oil and natural gas, manufacturing plants, social media platforms, mobile applications, government portals.

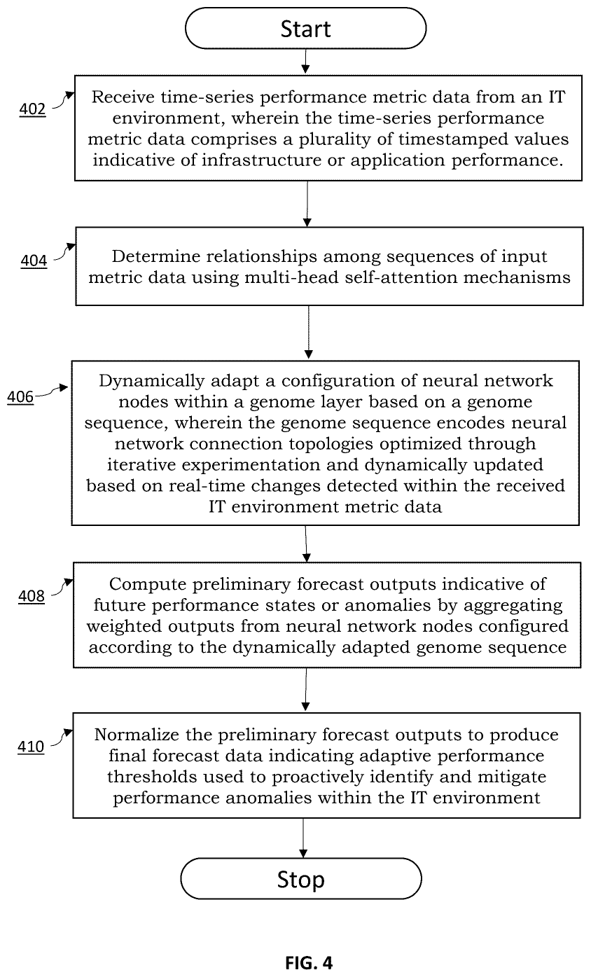

FIG. 4 depicts method steps of time series forecasting using a modified transformer according to an embodiment of the present disclosure. At a step 402, the hardware processor modified transformer receives time-series performance metric data from an IT environment, wherein the time-series performance metric data comprises a plurality of timestamped values indicative of infrastructure or application performance. At a step 404, it determines relationships among sequences of input metric data using multi-head self-attention mechanisms. At a step 406, the hardware processor dynamically adapts a configuration of neural network nodes within a genome layer based on a genome sequence, wherein the genome sequence encodes neural network connection topologies optimized through iterative experimentation and dynamically updated based on real-time changes detected within the received IT environment metric data. At a step 408, the hardware processor computes preliminary forecast outputs indicative of future performance states or anomalies by aggregating weighted outputs from neural network nodes configured according to the dynamically adapted genome sequence. At a step 410, the hardware processor normalizes the preliminary forecast outputs to produce final forecast data indicating adaptive performance thresholds used to proactively identify and mitigate performance anomalies within the IT environment.

The embodiments of the present disclosure are configured in such a way that any changes in the one or more genome sequence changes the one or more connections between the one or more neural networks and the configuration of the one or more neural networks. This is present to ensure that the neural network keeps changing according to the environment and the metrics and the requirement of forecasting. This drastically reduces the training period of training data and the processing capability required to process huge amount of data.

Various other embodiments of the same invention disclose a method comprising reshaping the final forecast data into a continuous reshared data and converting the continuous reshaped data into a time series output data by the hardware processor. It also discloses changing configuration of neural network nodes within the genome layer based on any changes in the genome sequence.

In another embodiment of the same disclosure by the hardware processor determines at least one adaptive upper threshold and at least one adaptive lower threshold for one or more metrics in the IT environment, based in the final forecast data. This is used to determine one or more anomalies in the IT Infrastructure based on the at least one adaptive upper threshold if the input data exceeds the adaptive upper threshold and the at least one adaptive lower threshold if the input data is below the adaptive lower threshold. The invention also discloses a method and system for assigning probability and severity scores to anomalies.

Further, the same system and methods can be adapted for performing AI-based Root Cause Analysis, wherein the hardware processor analyses directional information flow between metrics, identifies causal relationships across application boundaries and quantifies percentage contributions to anomalies.

In the primary embodiment of the present invention, the Genome-sequence is updated performed periodically rather than in real time. A refresh is triggered whenever hardware processor detects a statistically significant data-drift or live-forecast error moving outside a ±3σ±3σ control band, which in one of the embodiments happens every 4-6 weeks. Between refreshes, the system and method continue to work based on the previous genome. After the refresh has been done, the system and method work based on the new genome sequence.

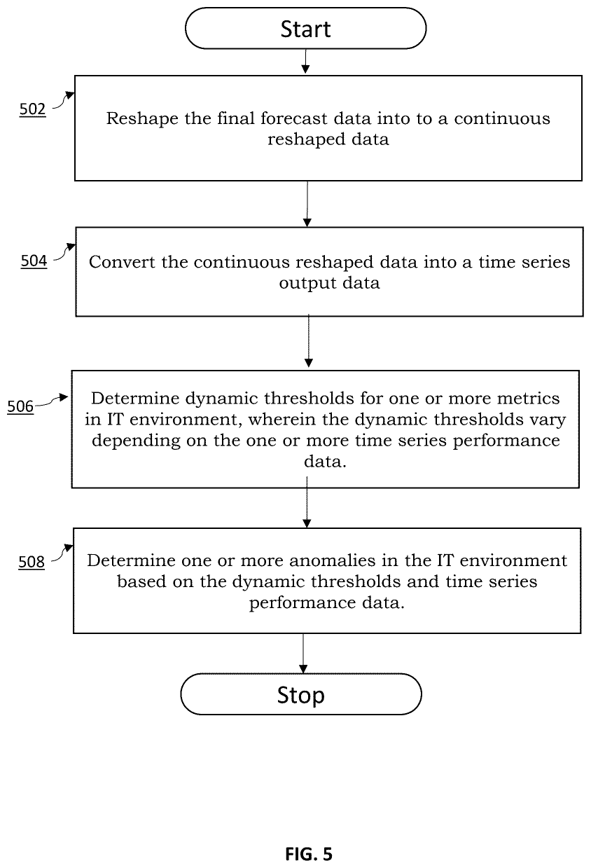

FIG. 5 depicts method steps of anomaly detection using a modified transformer according to an embodiment of the present disclosure. At a step 502, a reshape layer reshapes the normalised one or more preliminary output data to a continuous reshaped data. At a step 504, a time distribution layer converts the continuous reshaped data into a time series output data. At a step 506, the hardware processor determines one or more dynamic thresholds for one or more metrics in one or more time series input data, wherein the dynamic thresholds vary depending on the one or more time series input data. At a step 508, the hardware processor determines one or more anomaly metrics in the one or more environment based on the one or more dynamic thresholds.

Disclosed is also a system for time series forecasting using a modified transformer, comprising at least one hardware processor, a non-transitory computer-readable storage medium having stored thereon program instructions, the program instructions executable by the at least one hardware processor. It receives at least one or more time series input data and one or more environment data, from an input device, identifies one or more relationships between one or more sequence of inputs by at least one encoder layer, determines one or more connections between one or more neural networks and a configuration of the one or more neural networks based on one or more genome sequence in at least one genome layer, wherein the one or more genome sequence change with any changes in at least the one or more environment data, compute one or more preliminary output data by combining one or more initial output from one or more nodes associated with the one or more neural networks by the at least one genome layer and normalizes the one or more preliminary output data received from the at least one genome layer by the normalization layer.

Additional or less units can be included without deviating from the novel art of this disclosure. In addition, each unit can include any number and combination of sub-units, and systems, implemented with any combination of hardware and/or software units.

Throughout more disclosure the term “user device” refers to devices such as, but not limited to, a mobile phone, tablet, a laptop, a personal computer connected to a widely accessible network such as the Internet, any portable computing device connected to a widely accessible network such as the Internet, or any graphical user interface enabling a user to enter an input, a portable communication device, or a personal digital assistant connected to the one or more data communication network.

Method steps of the invention may be performed by one or more computer processors executing a program tangibly embodied on a computer-readable medium to perform functions of the invention by operating on input and generating output. Suitable processors include, by way of example, computers, laptops, both general and special purpose microprocessors.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “hardware processor” refers to data processing hardware and encompasses all kinds of apparatus, devices, and machines for processing data, including by way of example a programmable processor, a computer, or multiple processors or computers. The apparatus can also be, or further include, special purpose logic circuitry. The apparatus can optionally include, in addition to hardware, code that creates an execution environment for computer programs, e.g., code that constitutes processor firmware, a protocol stack, a database management system, an operating system, or a combination of one or more of them.

Throughout this disclosure, the term neural networks has been used, without limitation. Without limitation, it may refer to a method in artificial intelligence that teaches computers to process data in a way that is inspired by the human brain. It is a type of machine learning process, called deep learning, that uses interconnected nodes or neurons in a layered structure that resembles the human brain. The neural network disclosed in the present disclosure is a custom built neural network for the specific purpose and not any generic existing network.

The disclosed invention model is trained on GPUs and the model infer data using CPUs as it is not that resource intensive. Beneficially, the present disclosure can be leveraged for dynamic thresholding and anomaly detection within time series data. By using advanced techniques in the present disclosure, the systems and method offers unparalleled adaptability and precision.

As an example, without limiting the scope of the invention, the disclosed system and methods can be used for time series forecasting in any environment. One of the use case of the disclosed system is for AIOps. The system and methods can be modified to detect anomalies and performance of various processes and components in the IT Operations environment.

An alterative embodiment of the same invention can also be implemented for predicting results of a sport or a game and performance of different players. An alternative embodiment of the same invention can also be implemented to predict the power consumption and performance of various components in a power grid. Without limitation, the use case of the present disclosure is vast and the same is not limited to the embodiments disclosed herein.

As an illustration, a sample input to the system could be a time-series metric data which consist of timestamp and value along with some meta information related to metrics and environment. A sample input is produced below:

```
{
  “org_id”: “4d896abd-b424-450a-b840-db1738c60eec”,
  “tenant_id”: “cfc8b64c-e107-48f3-bd0c-4c6c070dff86”,
  “source_id”: “1f32bcdf-9dae-4a8a-b124-ccf4b78b62cb”,
  “application_data”: [
    {
      “application_id”: “0675cd02-c144-41c5-bd49-8e524ea83c84”,
      “metrics_data”: [
        {
          “metricname”: “rest_client_requests_total”,
          “metric_id”: “062be2b6-1a01-4eba-98d4-620a0f6e888e”,
          “values”: [
            {
              “time”: “2024-06-13 03:57:00”,
              “value”: 0
            },{
              “time”: “2024-06-13 03:58:00”,
              “value”: 0
            },
            {
              “time”: “2024-06-13 03:59:00”,
              “value”: 0
            },
            {
              “time”: “2024-06-13 04:00:00”,
              “value”: 0
            } .......
          ]
        }
      ]
    }
  ]}
```

Output of the model consists of the forecasted value against the timestamp along with upper threshold and lower threshold. A sample output is produced below:

```
  { “nid”: “e4f96afd-c0eb-46fd-adb4-5603b04297d3”,
    “event_time”: “2024-06-13 10:34:00”,
    “forecast_value”: 0.4817105829715729,
    “tenant_id”: “501ffb9e-4653-4ff7-8e51-0f8a1579a34f”,
    “application_id”: “d05530ef-6db3-4375-a50d-
    d6671285c7bb”, “resource_name”: “XX_YY”,
    “resource_type”: “cortex”,
    “metric”: “DB_CLIENT_REQ_TIMEOUT_RATE_4_Write-
    QUORUM”, “unit”: “gauge”,
    “tags”: [
      {
        “tag_name”: “xxxx1”,
        “tag_value”: “xxxx1”
      },
      {
        “tag_name”: “xxxx2”,
        “tag_value”: “xxxx2”
      }
    ],
    “ut”: 0.9950154957256119,
    “It”: 0,
    “query_id”: “06e4ca40-74b5-4ca2-95e3-e9617336b4c0”,
    “source_id”: “ea70e538-0e29-4dde-ac49-214effff9e90”
}
```

As example, anomaly detection in an IT Infrastructure in an E-commerce platform is analysed using the disclosed system and methods. During a flash sale, an online retailer experiences a sudden surge in online traffic and transactions. The system monitors multiple services including the checkout service, database, and payment gateway. When response times begin to exceed dynamically calculated thresholds, the system detects anomalies and initiates root cause analysis. The system collects metrics from all services involved in the flash sale, Metrics include response times, memory usage, database connections, and business metrics like cart abandonment rates. It is pertinent to note that since the input data corresponds to ecommerce, the genome sequence used for the same would be different and accordingly it sets up the required neural network, without any training data. Data is cleaned and normalized for consistent analysis using the dense layer. Historical patterns from previous flash sales are analyzed using transformer layer. The forecasted data is then reshaped and distributed in a time series. The system forecasts expected values for each metric during the sale period. Dynamic thresholds are calculated based on these forecasts. Based on the dynamic thresholds, anomaly Detection takes pace. As an example, at 12:15:00, the checkout service response time reaches 950 ms. This exceeds the dynamically calculated upper threshold of 850 ms. The system flags this as an anomaly with high severity and 92% confidence. The system can further be configured to perform Root

Cause Analysis as well. This AI-based system analyzes relationships between all metrics. As an example, it identifies that database connections (42.8%) and memory usage (35.2%) are the primary causes of the response time anomaly. It further determines that the response time issue is causing increased cart abandonment (78.5%). The system can further be configured for resolving the same as well. Mean time to resolution is significantly reduced across multiple systems.

In an alternative embodiment of the same invention, the said invention can also be built using a distributed ledger based platform such as blockchain. Additionally, smart contracts can be added wherein the smart contracts would facilitate processor for enabling the system and methods for time series forecasting using the modified transformer.

Without limitation, various embodiments of the present invention can also be used for use cases other than time series forecasting as well. The modified transformer with a genome sequence disclosed herein can be adapted for without limitation, text to voice, voice to text, image recognition, AI enabled virtual assistants such as ChatGPT.

Beneficially, some of the embodiments of the present technical solution may also be modified to provide benefits including but not limited to (a) drastically reducing processor requirements for time series forecasting; (b) drastically reducing the requirement of training data for time series forecasting; (c) significantly improved accuracy and efficiency in time series forecasting and predictions (d) helps in maintaining system reliability, optimizing resource utilization, and proactively addressing potential issues; (e) Provides for dynamic thresholding and anomaly detection within time series data; (f) Capacity planning is a proactive strategy minimizes the risk of resource shortages or excess, enhancing operational efficiency and cost-effectiveness. It enables organizations to maintain optimal performance levels while adapting to changing business requirements seamlessly.

The disclosed methods and systems provides sugnificant performance gains, in full 24 238-row hold-out set, as compared to existing methods and systems as follows

| Model | # Data Points | R² | Test MSE |
|---|---|---|---|
| Present Disclosure | 24238 | 0.82 | 0.159 |
| ETS Former | 24238 | 0.67 | 0.298 |
| Temporal Fusion Transformer | 24238 | 0.59 | 0.369 |
| LSTM Network | 24238 | 0.25 | 0.654 |
| Neural Prophet | 24238 | 0.09 | 0.824 |

The present disclosure delivers an approximately 47% lower MSE and a 15-point lift in R2 score relative to the next-best ETS Former baseline

The innovative forecasting approach for times series forecasting using modified transformer provides for dynamic thresholding and anomaly detection and it represents a significant advancement in the field. By integrating state-of-the-art techniques, the disclosed system and methods provide a robust and adaptable solution that enhances the accuracy and reliability of predictive models. This novel methodology sets a new standard in time series forecasting and anomaly detection, promising improved decision-making and risk management in various domains.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It will be understood that the application is not limited to the embodiments disclosed, but is capable of numerous rearrangements, modifications, and substitutions as set forth.

At least portions of the functionalities or processes described herein can be implemented in suitable computer-executable instructions. It will be appreciated that features of the present disclosure are susceptible to being combined in various combinations and additional features may be introduced without departing from the scope of the present disclosure. Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for dynamically forecasting performance anomalies in an Information Technology (IT) infrastructure environment, comprising:
receiving, by at least one hardware processor, time-series performance metric data from an IT environment, wherein the time-series performance metric data comprises a plurality of timestamped values indicative of infrastructure or application performance;
determining, by the at least one hardware processor executing a transformer neural network model comprising at least one encoder layer, relationships among sequences of input metric data using multi-head self-attention mechanisms;
dynamically adapting, by the hardware processor, a configuration of neural network nodes within a genome layer based on a genome sequence, wherein the genome sequence encodes neural network connection topologies optimized through iterative experimentation and dynamically updated based on real-time changes detected within the received IT environment metric data;
computing preliminary forecast outputs indicative of future performance states or anomalies by aggregating weighted outputs from neural network nodes configured according to the dynamically adapted genome sequence; and
normalizing the preliminary forecast outputs to produce final forecast data indicating adaptive performance thresholds used to proactively identify and mitigate performance anomalies within the IT environment.

2. The method of claim 1 comprising:
reshaping the final forecast data into a continuous reshared data and converting the continuous reshaped data into a time series output data by the hardware processor.

3. The method of claim 1 comprising changing a configuration of neural network nodes within the genome layer based on any changes in the genome sequence.

4. The method of claim 1 comprising determining, by the hardware processor, at least one adaptive upper threshold and at least one adaptive lower threshold for one or more metrics in the IT environment, based in the final forecast data.

5. The method of claim 1 comprising determining one or more anomalies in the IT Infrastructure based on the at least one adaptive upper threshold, the at least one adaptive lower threshold and the time-series performance metric data of the IT environment.

6. The method of claim 1 comprising updating the IT environment to rectify the one or more anomalies.

7. The method of claim 1 comprising updating the one or more genome sequence based at least on one or more successive transformations and one or more iterative optimization processes.

8. A system A method for dynamically forecasting performance anomalies in an Information Technology (IT) infrastructure environment, comprising:
at least one hardware processor; a non-transitory computer-readable storage medium having stored thereon program instructions, the program instructions executable by the hardware processor to:
receive time-series performance metric data from an IT environment, wherein the time-series performance metric data comprises a plurality of timestamped values indicative of infrastructure or application performance;
determine relationships among sequences of input metric data using multi-head self-attention mechanisms;
dynamically adapt a configuration of neural network nodes within a genome layer based on a genome sequence, wherein the genome sequence encodes neural network connection topologies optimized through iterative experimentation and dynamically updated based on real-time changes detected within the received IT environment metric data;
compute preliminary forecast outputs indicative of future performance states or anomalies by aggregating weighted outputs from neural network nodes configured according to the dynamically adapted genome sequence; and
normalize the preliminary forecast outputs to produce final forecast data indicating adaptive performance thresholds used to proactively identify and mitigate performance anomalies within the IT environment.

9. The system of claim 8 wherein the at least one hardware processor is configured to reshape the final forecast data into a continuous reshared data and convert the continuous reshaped data into a time series output data by the hardware processor.

10. The system of claim 8 wherein the at least one hardware processor is configured to change a configuration of neural network nodes within the genome layer based on any changes in the genome sequence.

11. The system of claim 8 wherein the at least one hardware processor is configured to determine at least one adaptive upper threshold and at least one adaptive lower threshold for one or more metrics in the IT environment, based in the final forecast data.

12. The system of claim 8 wherein the at least one hardware processor is configured to determine one or more anomalies in the IT Infrastructure based on the at least one adaptive upper threshold, the at least one adaptive lower threshold and the time-series performance metric data of the IT environment.

13. The system of claim 8 wherein the at least one hardware processor is configured to update the IT environment to rectify the one or more anomalies.

14. The system of claim 8 wherein the at least one hardware processor is configured to update the one or more genome sequence based at least on one or more successive transformations and one or more iterative optimization processes.
